(19) United States
(12) Patent Application Publication
(10) Pub. No.: US 2026/0098655 A1
(43) Pub. Date: Apr. 9, 2026

(54) SYSTEM FOR AUTOMATICALLY DEPLOYING A SMOKE CURTAIN AND ASSOCIATED SYSTEMS AND METHODS

(71) Applicant: Smoke Guard, Inc., Boise, ID (US)

(72) Inventors: Daniel Canaday, Boise, ID (US); Spencer Lynch, Boise, ID (US); Samuel Wallace, Boise, ID (US)

(21) Appl. No.: 18/911,212

(22) Filed: Oct. 9, 2024

(51) Int. Cl. F24F 13/12; F24F 11/74; F24F 13/18; A62C 2/18

(52) U.S. Cl. CPC F24F 13/12; F24F 11/74; F24F 13/18; A62C 2/18

(57) ABSTRACT

A system for blocking transmission of smoke through a passageway, and related systems and methods, are disclosed herein. In some embodiments, the system includes a housing, a deployable barrier positioned to move between a retracted position and a deployed position, a motor coupled to the deployable barrier, and a deploying circuit coupled to the motor. The weight of the deployable barrier can drive the motor in reverse during deployment to generate a current in an inductive component of the motor. The deploying circuit can have a first setting that applies the current to an output of the deploying circuit to dissipate the current and a second setting that applies the current as a load upstream from the inductive component to resist driving the motor in reverse. The system can also include a controller coupled to the deploying circuit to switch between the first setting and the second setting.

### TECHNICAL FIELD

The present disclosure relates generally to barrier systems and associated methods, including vapor and/or fire barrier systems, and more particularly to a system for automatically controlling a speed of descent of a smoke curtain during deployment.

### BACKGROUND

Smoke, fumes, and noxious gasses can be very dangerous to occupants during a building fire. It is well known that many fire-related deaths are the result of smoke inhalation. During a fire, or an event where dangerous gases may be present, fumes are likely to travel very quickly through paths that offer little resistance. Paths such as elevator shafts are often well-drafted and provide an excellent avenue by which smoke and other dangerous gases can rapidly travel to otherwise unaffected areas of a building. To prevent such a migration of dangerous gases, many devices and assemblies have been designed to limit the dispersal of such fumes by cutting off possible paths or openings. Examples of such devices are screen assemblies disclosed in U.S. Patent No. 7,000,668, titled System and Method for Sealing Openings in Response to Smoke, Noxious Fumes, or Contaminated Air Using a Roll-Down Barrier, issued Feb. 21, 2006; U.S. Patent No. 7,028,742, titled System and Method for Sealing Openings in Response to Smoke, Noxious Fumes, or Contaminated Air Using a Roll-Down Barrier, issued Apr. 18, 2006; U.S. Patent No. 7,299,848, titled Closing Member Control Systems, Including Door Control Systems for Barrier Housings, and Associated Methods, issued Nov. 27, 2007; U.S. Patent No. 9,038,693, titled Barrier Systems and Associated Methods, Including Vapor and/or Barrier Systems with Manual Egress, issued May 26, 2015; U.S. Patent No. 9,610,464, titled Deployable, Foldable Smoke/Fire Curtain Assembly, issued May 26, 2015; U.S. Patent Application Publication No. 2023/0133377, titled Deployable Fire or Smoke Barrier with Manual Egress, filed Nov. 1, 2022; each of which is incorporated herein by reference in its entirety.

### BRIEF DESCRIPTION OF THE DRAWINGS

FIG. 1 is a partially schematic drawing of a deployable barrier system configured in accordance with embodiments of the present technology.

FIG. 2 is a schematic block diagram of components of a deployable barrier system configured in accordance with embodiments of the present technology.

FIG. 3 is a circuit diagram of a deploying circuit configured in accordance with embodiments of the present technology.

FIG. 4 is a flow diagram of a process for deploying a curtain of a deployable barrier system in accordance with embodiments of the present technology.

FIG. 5 is a flow diagram of a process for controlling descent of a curtain of a deployable barrier system during deployment in accordance with embodiments of the present technology.

FIG. 6 is a flow diagram of a process for controlling descent of a curtain of a deployable barrier system during deployment in accordance with further embodiments of the present technology.

FIG. 7 is a flow diagram of a process for deploying a curtain of a deployable barrier system in accordance with further embodiments of the present technology.

The drawings have not necessarily been drawn to scale. Similarly, some components and/or operations can be separated into different blocks or combined into a single block for the purpose of discussion of some of the implementations of the present technology. Moreover, while the technology is amenable to various modifications and alternative forms, specific implementations have been shown by way of example in the drawings and are described in detail below. The intention, however, is not to limit the technology to the particular implementations described.

### DETAILED DESCRIPTION

### Overview

Systems and methods for automatically deploying a curtain are disclosed herein. More specifically, the systems and methods disclosed herein include a gravity-driven deployment mechanism that includes a deploying circuit to control a speed of the curtain being pulled by gravity. The curtain, once deployed, can act as a barrier to smoke, fire, fumes, noxious gasses, and/or the like. The deploying circuit can include an H-bridge circuit that is switchable between a first setting (e.g., a fast decay setting) and a second setting (e.g., a slow decay setting) thousands of times per second. The rapid switching of the deploying circuit helps ensure controlled, smooth velocities during the curtain’s descent. Further, gravity pulling the curtain generates a current in the deploying circuit. When the deploying circuit is in the first setting, the deploying circuit can load the current onto an output of the deploying circuit, allowing the current to charge a battery of the system and/or help (or fully) power a controller coupled to the deploying circuit. Still further, the circuit-driven control of the descent allows the systems disclosed herein to eliminate failure mechanisms associated with mechanical dampeners and/or other mechanical control components.

In some embodiments, the systems disclosed herein are configured to self-calibrate (e.g., reset after encountering an interuptions, search for and/or identify a fully deployed position, and/or the like). The self-calibration can help ensure accurate and reliable operation of the barrier system, even in cases where the system is incorrectly calibrated during initial installation. For example, in the case where a position is initially set in calibration where the curtain is not fully deployed, the systems and methods disclosed herein can search and learn the full deployment distance upon a second deployment. Furthermore, the systems and methods disclosed herein incorporate a soft landing near an anticipated end of the deployment motion. The soft landing provides an additional layer of protection to the components of the system that can help increase overall robustness and/or help mitigate the risk of system malfunctions due to calibration errors.

In some embodiments of the present technology, the system (sometimes referred to as a “deployable barrier system”) includes a housing, a deployable barrier, a motor operably coupled to the deployable barrier, a deploying circuit operatively coupled to the motor, and a controller operably coupled to the deploying circuit. The deployable barrier can be movable between a retracted position within the housing and a deployed position at least partially outside of the housing. Further, the deployable barrier can include a curtain configured to cover the passageway and block smoke from moving through a passageway when the deployable barrier is in the deployed position. The motor can be operably coupled to the deployable barrier so that a weight of the curtain drives the motor in reverse during deployment of the deployable barrier system. Further, the motor can include an inductive component positioned to generate a current in response to the motor driving in reverse. The deploying circuit can have a first setting and a second setting to make different uses of the current. In the first setting (e.g., a fast decay setting), the deploying circuit applies the current to an output of the deploying circuit to dissipate the current. The dissipation allows the curtain to move quickly with little (or effectively no) resistance. Conversely, in the second setting (e.g., a slow decay setting), the deploying circuit applies the current as a load upstream from the inductive component to resist driving the motor in reverse. The controller can switch the deploying circuit between the first setting and the second setting rapidly to automatically and electronically control a speed of the motor driving in reverse, thereby controlling a speed of the descent of the curtain.

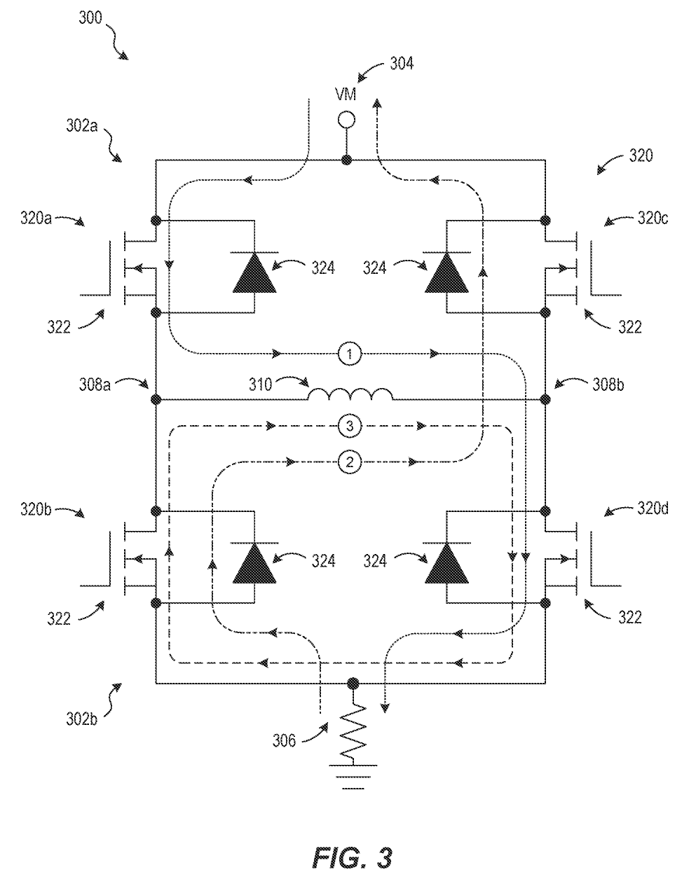

For ease of reference, the deployable barrier system (and components thereof) is sometimes described herein with reference to top and bottom, upper and lower, left and right, and/or horizontal plane, x-y plane, vertical, or z-direction relative to the spatial orientation of the embodiments shown in the figures. For example, components of the deploying circuit are frequently discussed herein with reference to the specific spatial orientation illustrated in FIG. 3. It is to be understood, however, that the deployable barrier system (and components thereof) can be moved to, and used in, different spatial orientations without changing the structure and/or function of the disclosed embodiments of the present technology.

Further, “block” is used herein with reference to materials that can fully block, partially block, and/or impede the flow of smoke, fire, fumes, noxious gasses, and/or the like through the relevant components of the deployable barrier system (e.g., the curtain). Accordingly, for example, deploying the curtain to block smoke from flowing through a passageway should not be read to require that the curtain prevents all snoke from flowing through the passageway.

Still further, although primarily discussed herein as a deployable barrier system to smoke from moving through a passageway (e.g., an elevator doorway), one of skill in the art will understand that the scope of the invention is not so limited. For example, the deployable barrier system can also be used to block fire, fumes, noxious gasses, and/or other hazards. In another example, the deployable barrier system can be implemented in various other settings, such as blocking various other doorways, halls, common air-flow spaces, and/or the like. Accordingly, the scope of the invention is not confined to any subset of embodiments, and is confined only by the limitations set out in the appended claims.

### Description of the Figures

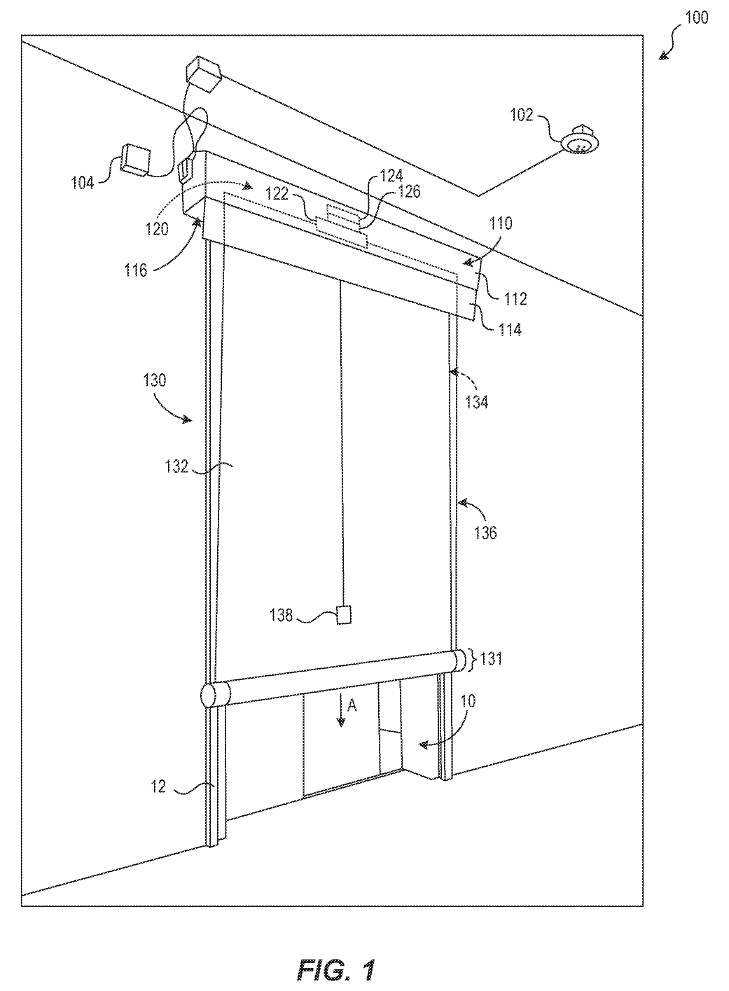

FIG. 1 is a partially schematic drawing of a deployable barrier system 100 configured in accordance with embodiments of the present technology. The deployable barrier system 100 (“system 100”) is positioned adjacent to a passageway 10 of a building, such as a doorway of an elevator system, a stairwell, a hall of a building, and/or any other common flow path for air through the building. Accordingly, the system 100 can block the flow of smoke, fire, fumes, noxious gasses, and/or the like through the passageway 10 and into the common flow paths, which can otherwise serve as a highway for the smoke fire, fumes, noxious gasses, and/or the like during an emergency. As a result, the system 100 can help improve the safety of a building during an emergency by impeding the spread of a fire through a building and/or containing the fire; blocking smoke, fumes, noxious gasses and/or the like into other parts of the building that are not on fire; and/or creating safe harbors within the building where the smoke, fire, fumes, noxious gasses, and/or the like cannot reach (or are slow to reach).

As illustrated n FIG. 1, the system 100 can include a housing 110 that is positioned above the passageway 10, as well as a deploying system 120 and a deployable barrier 130 that are each positioned at least partially within the housing 110. The housing 110 can include exterior panels 112 and a door 114. The door 114 can move between a closed position to conceal the system 100 and an open position to create an opening 116 in the housing 110 that is oriented toward the passageway 10. The opening 116 can allow, for example, the deployable barrier 130 to move between a first position (e.g., a retracted position) fully within the housing 110 and a second position (e.g., a deployed position) blocking the passageway 10. It will be understood, however, that the housing 110 can omit the door 114 altogether (e.g., to have a permanent opening) or include the door 114 on any other suitable surface (e.g., a sidewall of the housing 110).

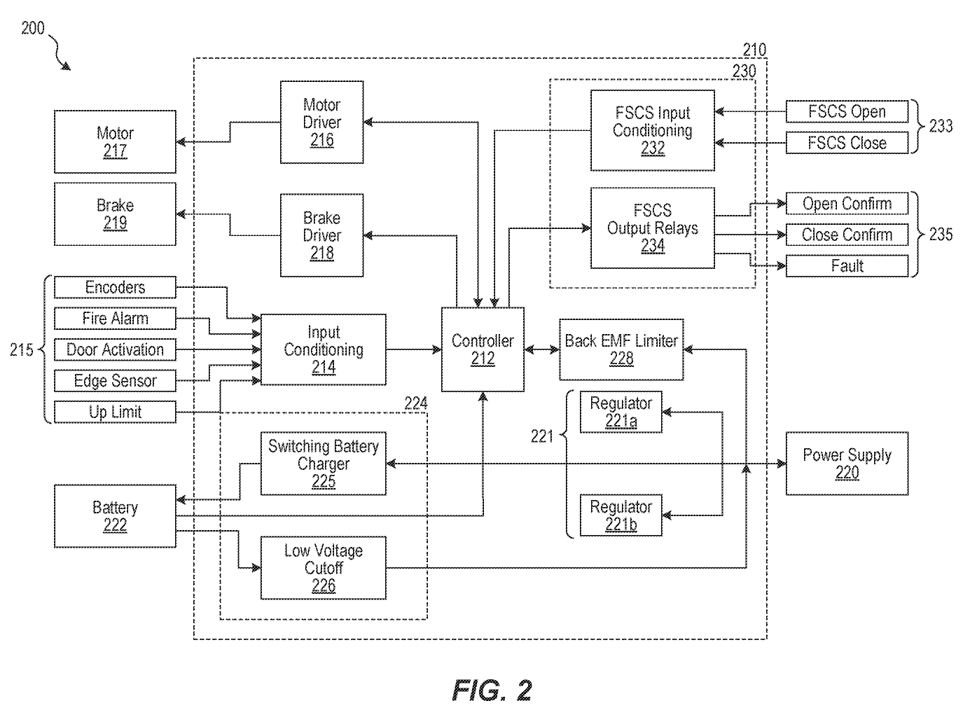

The deploying system 120 can include a motor 122, a controller 124, and a deploying circuit 126 operably coupled between the motor 122 and the controller 124. Additional details on the components of the deploying system 120, and their intercoupling, are discussed below with reference to FIGS. 2 and 3. The motor 122 can be operably coupled to the deployable barrier (e.g., by one or more drive shafts, pully mechanisms, cords, drive belts, and/or the like) such that driving the motor 122 in a first direction moves the deployable barrier from the second position toward the first position (e.g., retracts the deployable barrier) and driving the motor 122 in a second direction moves the deployable barrier from the first position toward the second position (e.g., deploys the deployable barrier).

As further illustrated in FIG. 1, the deployable barrier 130 can include a spool 131 and a curtain 132 that can unwind from and wind into the spool 131 during deployment and retraction, respectively. The curtain 132 can include any suitable material to block smoke, fire, fumes, noxious gas, and/or the like from flowing therethrough. In a specific, non-limiting example, the curtain 132 can include a DuraNet^{TM} translucent screen. Further, in the illustrated embodiment, the spool 131 is coupled to the deploying system 120 via suspension cables 134 and movable between a first position within the housing 110 when the deployable barrier 130 is retracted and a second position when the deployable barrier 130 is deployed. Said another way, the spool 131 is configured to be pulled through the opening 116 in the housing 110 toward the ground by gravity along a vertical motion path A during deployment of the deployable barrier 130.

As the spool 131 moves along the vertical motion path A, the curtain 132 unwinds from the spool 131 to cover the passageway 10 and the suspension cables 134 drive the motor 122 in the deploying system 120 in reverse. Further, as discussed in more detail below, the deploying system 120 can help control a speed of the deployable barrier 130 during the descent. For example, as the curtain 132 unwinds from the spool 131, the suspension cables 134 can drive the motor 122 in reverse. As discussed in more detail below, however, the deploying circuit 126 can automatically control the speed of the motor 122, thereby controlling a speed of the suspension cables 134 and, in turn, the speed of the spool 131. As a result, the deploying system 120 can help ensure that the spool 131 (or any other bottom edge) moves along the vertical motion path A within a predetermined speed range (e.g., between about six inches per second and about twenty-four inches per second) or at a predetermined speed (e.g., at about eleven inches per second). To retract the deployable barrier 130, the deploying system 120 can drive the motor 122 forward. As a result, the suspension cables can drive the spool 131 to wind the curtain 132 into the spool 131, thereby retracting the deployable barrier 130 into the retracted position.

As further illustrated in FIG. 1, the deployable barrier 130 can include sealing edges 136 and a manual switch 138. The sealing edges 136 are positioned at peripheral edges of the curtain 132 to grip, mate with, join, and/or otherwise connect to edges 12 of the passageway 10. For example, the sealing edges 136 can include a flexible magnetic component that is attracted to metal rails on the edges 12 of the passageway 10. As a result, the sealing edges 136 can help block smoke, fumes, fire, noxious gasses, and/or the like from flowing around the peripheral edges of the curtain 132 to flow through the passageway 10. The manual switch 138 is accessible on the curtain 132 and operatively coupled to the controller 124 in the deploying system 120. The manual switch 138 can allow an operator (e.g., a civilian, rescue personnel, and/or the like) to temporarily (or permanently) retract the deployable barrier 130. That is, activation of the manual switch 138 can cause the controller 124 to drive the motor 122 forward, thereby temporarily (or permanently) winding the curtain 132 back into the spool 131.

In various other embodiments, the components of the deployable barrier 130 can include various alternative arrangements and/or components. For example, the spool 131 can be positioned to wind and unwind fully within the housing 110 (e.g., coupled to and/or carried by a drive shaft of the motor 122). In some such embodiments, the curtain 132 has a weighted bottom edge and/or is coupled to a weighted component that is pulled along the vertical motion path A by gravity to unwind the curtain 132 and deploy the deployable barrier 130. Further, in some such embodiments, the deployable barrier 130 can omit the suspension cables 134 between the spool 131 and the motor 122. In another example, the curtain 132 can have a foldable configuration (e.g., an accordion fold, a pleated curtain, and/or the like). In such embodiments, the curtain 132 can include a weighted bottom edge and/or be coupled to a weighted component that can be pulled along the vertical motion path A by gravity to deploy the deployable barrier 130. Further, in such embodiments, the deployable barrier 130 can omit the spool 131 and instead include the suspension cables 134 coupled between the bottom edge of the curtain 132 (and/or the weighted component) and the motor 122.

Returning to the description of FIG. 1, the system 100 can include (or be communicatively coupled to) various components external to the housing 110 by one or more connection lines 102. For example, in the illustrated embodiment, the system 100 is communicably coupled to one or more sensors 104 (e.g., smoke detectors, noxious gas detectors, fire detectors, fire alarms, temperature sensors, edge sensors, and/or the like). More specifically, the sensors 104 can be communicatively coupled to the deploying system 120 via the connection lines 102. As a result, the deploying system 120 can receive signals indicating a detection of smoke, fire, fumes, noxious gas, and/or the like. The deploying system 120 can then deploy the deployable barrier 130 to block the passageway 10.

FIG. 2 is a schematic block diagram of components of a deploying system 200 configured in accordance with embodiments of the present technology. The deploying system 200 can be implemented within a broader system (e.g., the system 100 of FIG. 1) to control a deployable barrier (e.g., the deployable barrier 130 of FIG. 1). In the illustrated embodiment, the deploying system 200 can include an electronics subsystem 210 operatively coupled to various peripheral components. The electronics subsystem 210 includes a controller 212. The controller 212 can include a processing unit (e.g., a computer processing unit, graphics processing unit, and/or any other suitable processor), a memory storing instructions that can be implemented by the processing unit to execute any of the functions of the controller discussed herein, one or more logic units that implement functions of the controller, and/or any other suitable components.

The controller 212 is coupled to an input conditioning module 214 that, in turn, can be coupled to one or more input generators 215 (five illustrated in FIG. 2). The input generators 215 can include encoders that measure a speed of the deployable barrier during deployment and/or retraction, a fire alarm (or any other suitable alarm) that can detect an emergency situation and/or receive signals related to a detected emergency situation; a door activation component that is responsive to the fire alarm and/or a manual input (e.g., the manual switch 138 of FIG. 1) to deploy and/or retract the deployable barrier; one or more edge sensors such as smoke sensors, fume sensors, noxious gas sensors, temperature sensors, motion sensors, machine-vision sensors, and/or the like; an up-limit module positioned to detect when the deployable barrier is fully retracted and send a signal regarding the detection; and/or any other suitable components. Each of the input generators 215 can generate signals that are communicated to the input conditioning module 214 through a suitable communication channel (e.g., a wired and/or wireless communication channel). The input conditioning module 214 receives the signals and processes them to format the input signals for use in the controller 212.

As further illustrated in FIG. 2, the controller 212 can be coupled to a motor driver 216 and a brake driver 218 to control operation of the motor driver 216 and the brake driver 218. The motor driver 216, in turn, is coupled to a motor 217. The motor driver 216 can drive the motor 217 in a forward direction to retract a deployable barrier and/or back-drive the motor (e.g., by gravity acting on the deployable barrier) to deploy the deployable barrier. In some embodiments, the motor driver 216 includes the deploying circuit 126 discussed above with reference to FIG. 1. In various other embodiments, the deploying circuit 126 can be integrated with the motor 217 itself, the controller 212, and/or any other suitable component in the deploying system 200.

Similar to the motor driver 216, the brake driver 218 is coupled to a brake 219. The brake 219 can be a mechanical brake that can be applied to the motor 217 to slow and/or stop movement in the motor 217. Further, the brake 219 can help prevent the motor 217 from moving. For example, the brake driver 218 can apply the brake 219 to the motor 217 after fully retracting the deployable barrier to prevent the deployable barrier from deploying without needing to constantly drive the motor 217. In another example, the brake driver 218 can apply the brake 219 to the motor 217 when an obstacle is detected during deployment (e.g., in response to a human trying to move underneath the deployable barrier).

As further illustrated in FIG. 2, the electronics subsystem 210 can be coupled to an external power supply 220 (e.g., building power, the electric grid, an external generator, a 24V power supply (e.g., a battery), and/or the like) and a backup power source, such as a battery 222. When the external power supply 220 is available, the external power supply 220 can provide an input power to a regulator subsystem 221 to smooth the input. The regulator subsystem can include a high voltage regulator 221a and a low voltage regulator 221b to condition power inputs for a variety of the components in the electronics subsystem 210. For example, the regulator subsystem 221 can then direct power to the controller 212 (and/or any of the components coupled thereto, such as the motor driver 216) and/or a charging subsystem 224 coupled to the battery 222. As illustrated in FIG. 2, the charging subsystem 224 can include a switching battery charger 225 and a low voltage cutoff 226 each coupled to the battery 222. The switching battery charger 225 allows high voltage and/or high currents to be directed to the battery 222 to quickly charge the battery 222 when the external power supply 220 is available. The low voltage cutoff 226 can decouple the battery 222 from the external power supply 220 once the battery 222 is fully (or generally fully) charged to avoid over-charging.

The battery 222 can provide power to the controller 212 (and/or any of the components coupled thereto) when the external power supply 220 is unavailable and/or to reduce reliance on the external power supply 220. For example, during a fire, a building may lose power. In this scenario, the battery 222 can allow the deploying system 200 to safely deploy a deployable barrier, retract the deployable barrier in response to manual inputs from humans, and/or otherwise respond to prompts.

Further, the controller 212 can be coupled to the switching battery charger 225 to provide an input power to charge the battery 222. For example, as discussed in more detail below, the deploying circuit in the electronics subsystem 210 can generate a current when the motor is back-driven (e.g., in response to gravity pulling on the deployable barrier). The controller 212 can use the current to power itself, power any other suitable components coupled to the controller 212, and/or charge the battery 222. As a result, the deploying process itself can help provide power within the deploying system 200. In some embodiments, the battery 222 and/or the controller 212 can also send power external from the deploying system 200. For example, after the deployable barrier is in the deployed position, the battery 222 can communicate power (including power generated by the descent of the deployable barrier) to external emergency systems (e.g., backup lights, alarms, and/or the like). Still further, to help reduce the chance that the voltages and currents generated by (and applied to) the motor 217 cause damage, the electronics subsystem 210 can further include a back electromotive force (EMF) limiter 228.

As further illustrated in FIG. 2, the controller 212 can be coupled to a Firefighters Smoke Control Station (FSCS) module 230 that allows a firefighting team and/or a fire-response system to remotely operate the deploying system 200. For example, the FSCS module 230 includes an FSCS input conditioning submodule 232 and an FSCS output relay submodule 234. The FSCS input conditioning submodule 232 can receive open/close commands 233 (e.g., from the fire-response system) and relay the commands to the controller 212. The controller 212 will then retract/deploy the deployable barrier. As a result, for example, the FSCS module 230 can allow the deploying system 200 to be operated manually (or remotely) in response to a fire elsewhere in the building to mitigate the spread of smoke, fumes, fire, noxious gasses, and/or the like before the fire spreads. The FSCS output relay submodule 234 communicates status updates from the deploying system 200 as outputs 235. Returning to the example above, the outputs 235, can allow the building-wide fire system to confirm that the deployable barriers have been deployed, confirm the deployable barriers have been retracted, and/or identify faults in the system that need a response.

FIG. 3 is a circuit diagram of a deploying circuit 300 configured in accordance with embodiments of the present technology. As discussed above, the deploying circuit 300 can be coupled between a controller of a deployable barrier system and a motor of the deployable barrier system to help automatically control the speed of the motor during the deployment of a curtain (or other barrier). In various embodiments, the deploying circuit can be integrated with the controller (e.g., the controller 124 of FIG. 1, the controller 212 of FIG. 2, and/or the like) and/or with the motor (e.g., the motor 122 of FIG. 1, the motor 217 of FIG. 2, and/or the like). Further, in various embodiments, the deploying circuit 300 can be constructed from discrete components, constructed in an integrated chip that can be coupled to the system, and/or the like.

In the illustrated embodiment, the deploying circuit 300 is an H-bridge circuit that has a top half 302a and a bottom half 302b opposite the top half 302a. The top half 302a has a first output terminal 304 that can be coupled to a controller (e.g., the controller 212 of FIG. 2), a power supply (e.g., the external power supply 220 and/or the battery 222 of FIG. 2), and/or any other suitable supply rail. The bottom half 302b has a second output terminal 306 that can be coupled to a ground. Further, the top half 302a is separated from the bottom half 302b by a first motor terminal 308a and a second motor terminal 308b on left and right sides, respectively, of the deploying circuit 300. The first and second motor terminals 308a, 308b are coupled to an inductor 310 of a motor (e.g., the motor 122 of FIG. 1, the motor 217 of FIG. 2, and/or the like). As a result, the deploying circuit is formed around (e.g., centered around) the inductor 310 (sometimes also referred to herein as an “induction component”).

As further illustrated in FIG. 3, the deploying circuit 300 can include a plurality of switches 320 that can be opened and closed to define different control paths through the inductor 310 to control the operation of the motor. For example, in the H-bridge embodiment of FIG. 3, the deploying circuit includes a first switch 320a on the left side of the top half 302a, a second switch 320b on the left side of the bottom half 302b, a third switch 320c on the right side of the top half 302a, and a fourth switch 320d on the right side of the bottom half 302b. Further, in the illustrated embodiment, each of the switches 320 includes a transistor 322 (e.g., a field-effect transistor (FET), a metal–oxide–semiconductor field-effect transistor (MOSFET), and/or the like) that can be turned on and off to close and open the switches 320. The switches 320 can also include diodes 324 (sometimes referred to herein as “catch-diodes”) that provide a path for current in the deploying circuit 300 while the switches 320 are opened and closed (e.g., to help provide voltage in the inductor 310 from spiking as the switches 320 opened and closed).

The deployable barrier system can set the deploying circuit 300 in a forward-drive state by closing the first and fourth switches 320a, 320d and opening the second and third switches 320b, 320c. In the forward drive state, an input power applied to the first output terminal 304 results in a current flowing along the first path 1 in FIG. 3, thereby driving the motor forward and retracting the deployable barrier. In contrast, when the deployable barrier system lowers the deployable barrier, gravity pulls on the deployable barrier and drives the motor in reverse, thereby generating a current in the inductor 310. During the descent, the deployable barrier system can switch the deploying circuit 300 between a first decay setting and a second decay setting to electronically control a speed of the motor and therefore electronically control a speed of the descent.

To set the deploying circuit 300 in the first decay setting (e.g., a fast decay setting), the deployable barrier system can close the second and third switches 320b, 320c and open the first and fourth switches 320a, 320d. In the first decay setting, the current from the inductor 310 can travel along a second path 2 into the first output terminal 304 and away from the deploying circuit 300. As a result, the deploying circuit 300 does not resist the descent of the deployable barrier (e.g., allows the deployable barrier to free fall), thereby increasing a speed of the deployable barrier.

To set the deploying circuit 300 in the second decay setting (e.g., a slow decay setting), the deployable barrier system can close the second and fourth switches 320b, 320d and open the first and third switches 320a, 320c. In the second decay setting, the current from the inductor 310 can travel along a third path 3 to load the current on the first motor terminal 308a upstream from the inductor 310. As a result, the deploying circuit 300 can create a current difference across the inductor 310 of zero (or about zero after losses in the deploying circuit 300) to decelerate the motor and slow the descent of the deployable barrier. Said another way, the deploying circuit 300 uses the current generated by the motor driving in reverse to electronically brake (and/or stop) the motor, thereby electronically braking the descent of the deployable barrier.

By switching the deploying circuit 300 between the first decay setting and the second decay setting, the deployable barrier system can switch between accelerating and decelerating the descent of the deployable barrier. That is, the deploying circuit 300 allows the deployable barrier system to control the speed of the descent entirely using electronic components of the deploying circuit 300. Further, by controlling the time spent in each setting, the deployable barrier system can control the speed of the descent of the deployable barrier. For example, the more time spent in the fast decay setting, the faster the deployable barrier will descend. Conversely, the more time spent in the slow decay setting, the slower the deployable barrier will descend. In various embodiments, the deployable barrier system, via the deploying circuit 300, can control the speed of the descent of the deployable barrier such that a lowermost edge of the deployable barrier moves in a vertical direction at a speed between about six inches per second (“ips”) and about twenty-four ips, between about eight ips and about fifteen ips, or about eleven ips.

Further, the deploying circuit 300 can switch between the first decay setting and the second decay setting thousands and/or tens of thousands of times per second. The rapid switching can allow the deploying circuit 300 to create a smooth descent (e.g., rather than visible and/or measurable stopping and starting). In various embodiments, the deploying circuit 300 can switch between the first decay setting and the second decay setting between about 1000 times per second and about 40,000 times per second, between about 10,000 times per second and about 30,000 times per second, and/or about 20,000 times per second. In addition to helping create a smooth descent, switching at a rate of about 20,000 times per second can cause the switching process to be above an audible range for humans, thereby reducing (or eliminating) audible noise from the deployable barrier system during deployment.

The deploying circuit 300 has numerous benefits in addition to providing control over the speed of the deployable barrier. For example, the electronic control of the speed can allow the deployable barrier system to reduce (or eliminate) reliance on mechanical systems to control the speed of the descent that can require maintenance and/or fail when external power is not available. In another example, because the deploying circuit 300 loads the current from the inductor 310 upstream from the inductor 310, the deploying circuit 300 brakes the deployable barrier using only current generated by the descent of the deployable barrier. That is, the deploying circuit 300 does not rely on external power to electronically brake the motor (and the deployable barrier). In yet another example, the current exported from the deploying circuit 300 in the first decay setting can be directed to a controller. In some embodiments, the current exported from the deploying circuit 300 in the first decay setting fully powers the controller (and related components of the deployable barrier system) during deployment, thereby reducing (or eliminating) reliance on external power. As a result, the deploying circuit 300 can allow the deployable barrier to be deployed during a partial and/or full blackout (e.g., when a building loses power during a fire). Said another way, the power exported from the deploying circuit 300 can fully power a controller coupled to the deploying circuit to switch between the first and second decay settings and control the speed of the deployable barrier. As a result, the deployable barrier system can eliminate the battery. Additionally, or alternatively, the current exported from the deploying circuit 300 in the first decay setting can be directed to a battery to provide power to various other components of the deployable barrier system (e.g., the rewind of the deployable barrier in response to activation of the manual switch 138 of FIG. 1, auxiliary lights and/or auxiliary emergency systems, and/or the like).

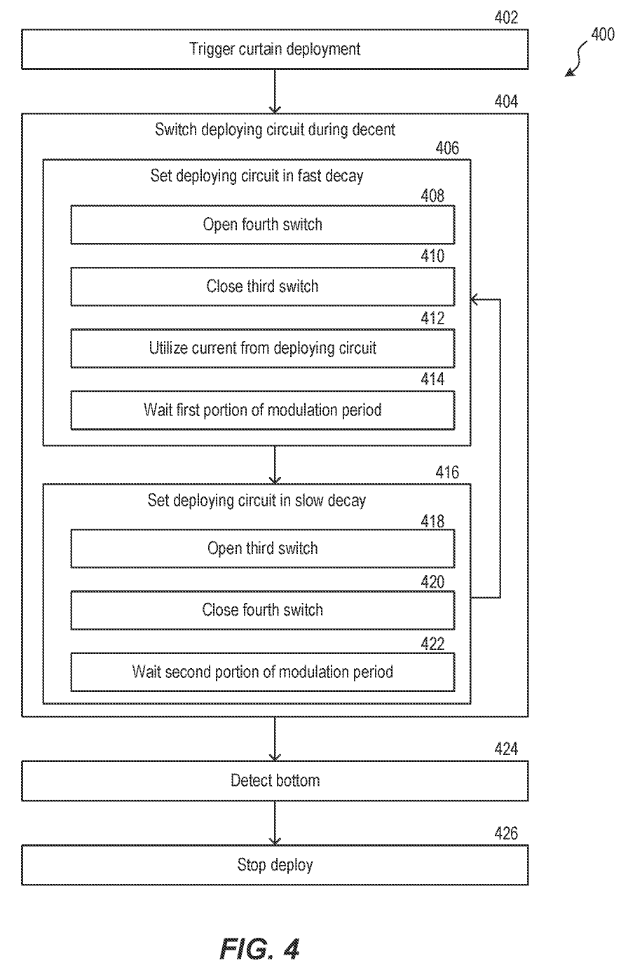

FIG. 4 is a flow diagram of a process 400 for deploying a curtain of a deployable barrier system in accordance with embodiments of the present technology. The process 400 can be executed by a controller in the deployable barrier system, such as the controller 124 discussed above with reference to FIG. 1 and/or the controller 212 discussed above with reference to FIG. 2. Additionally, or alternatively, various portions of the process 400 can be executed by any other suitable component in communication with the deployable barrier system. Further, the process 400 can be executed, in part, using a deploying circuit of the type discussed above. Accordingly, the process 400 is described herein with frequent reference to the deploying circuit 300 of FIG. 3.

The process 400 begins at block 402 by triggering curtain deployment. The process 400 can trigger the curtain deployment in response to a variety of inputs. For example, the inputs can be based on a detection of smoke, fumes, fire, noxious gasses, and/or any other hazard in the vicinity of the deployable barrier system (e.g., inputs from the input generators 215 of FIG. 2, a manual alarm system (e.g., a fire alarm level), and/or the like) and/or elsewhere in a building related to the deployable barrier system (e.g., inputs from the FSCS module 230 of FIG. 2, a central management system, and/or the like). Additionally, or alternatively, the inputs can be received from a manual switch in the deployable barrier system (e.g., the manual switch 138 of FIG. 1). The process 400 at block 402 can include opening one or more doors in the deployable barrier system to allow a curtain to be pulled by gravity from a retracted position toward a deployed position. Additionally, or alternatively, process 400 at block 402 can include releasing one or more brakes applied to the curtain and/or a motor coupled thereto to enable the curtain to begin descending. As discussed above, the descent can drive the motor of the deployable barrier system in reverse, thereby generating a current in an inductor therein.

At block 404, the process 400 includes switching a deploying circuit coupled to the motor between a first decay setting (e.g., a fast decay setting) at sub-block 406 and a second decay setting (e.g., a slow decay setting) at sub-block 416. As discussed above, the switching allows the process 400 to control the speed of the curtain during the descent.

To set the deploying circuit in the fast decay setting at sub-block 406, the process 400 can open a fourth switch (and a first switch, if closed) of the deploying circuit at step 408 (e.g., opening the first and fourth switches 320a, 320d of FIG. 3) and close a third switch (and a second switch, if open) at step 410 (e.g., closing the second and third switches 320b, 320c of FIG. 3). In some embodiments, the switches are opened and closed using a pulse-width modulation (PWM) signal applied to transistors in the switches. In some embodiments, step 408 and step 410 are implemented generally simultaneously. However, it can be important to ensure that the third and fourth switches (e.g., the third and fourth switches 320c, 320d of FIG. 3) are not closed at the same time to avoid forming a short in the deploying circuit. Similarly, it can be important to ensure that the first and second switches (e.g., the first and second switches 320a, 320b of FIG. 3) are not closed at the same time to avoid forming a short in the deploying circuit (though the first switch will remain open throughout the deploying process).

As discussed above, the fast decay setting provides the current from the inductor to an outlet terminal of the deploying circuit (e.g., the first output terminal 304 of FIG. 3) to be taken away from the deploying circuit. That is, the current from the inductor is available to components outside of the deploying circuit. Accordingly, at optional step 412, the process 400 includes utilizing the current from the deploying circuit to power the controller, charge a battery in (or coupled to) the deployable barrier system, and/or provide power outside of the deployable barrier system. Similar to the discussion above, the utilization of the current at optional step 412 can allow the process 400 to be executed independent from an external power supply (e.g., in the event of a partial, or full, blackout).

At step 414, the process 400 waits a first portion of a modulation period with the deploying circuit in the fast decay setting. The modulation period can be a thousandth, ten thousandth, and/or hundred thousandth of a second. Further, the first portion can be any suitable fraction of the modulation period (e.g., one hundredth, on tenth, one-fifth, one quarter, on third, one-half, two-fifths, two-thirds, three-quarters, and/or any other suitable fraction).

To set the deploying circuit in the slow decay setting at sub-block 416, the process 400 can open the third switch of the deploying circuit at step 418 (e.g., opening the third switch 320c of FIG. 3) and close a fourth switch at step 420 (e.g., closing the fourth switch 320d of FIG. 3). Similar to the discussion above, the switches can be opened and closed using a PWM signal applied to transistors in the switches. Further, steps 418, 420 can be implemented generally simultaneously. However, it can be important to ensure that the third and fourth switches (e.g., the third and fourth switches 320c, 320d of FIG. 3) are not closed at the same time to avoid forming a short in the deploying circuit.

At step 422, the process 400 waits a second portion of a modulation period with the deploying circuit in the slow decay setting. The second portion can be any suitable fraction of the modulation period that can be combined with the first portion to complete (or generally complete when opening and closing the switches requires a portion of the modulation period) the modulation period. For example, when the first portion is about two-thirds of the modulation period, the second portion can be about one-third of the modulation period. The fast decay setting allows the curtain to accelerate in response to gravity. As a result, the larger the first portion is as compared to the second portion, the faster the curtain is deployed. Accordingly, the first and second portions can be set and/or chosen to control the speed of the curtain during the descent to a selected speed. The speed can be selected to deploy the curtain quickly while reducing the chance of damage to the deployable barrier system from a freefall, reducing the chance of damage and/or harm caused by the deployable barrier system (e.g., to a human or object below the curtain during the descent), to comply with regulatory requirements, and/or the like.

In some embodiments, the first and second portions of the modulation period are varied throughout (and/or at various points of) the descent of the curtain. For example, the first portion can be relatively large at the start to accelerate the curtain, reduced once the curtain is at the selected speed, and reduced near the end of deployment for a soft landing in the deployed state. In another example, the first portion can be reduced in response to a detected obstruction (e.g., when a human passes beneath the curtain, when the curtain impacts an unknown object during descent, and/or the like) to enter an error state and slow the movement of the curtain.

After waiting the second portion of the modulation period at step 422, the process 400 can return to step 408 and repeat sub-blocks 406, 416 thousands, or tens of thousands, of times while the curtain is deployed. As discussed above, the rapid switching between the fast decay setting and the slow decay setting can help smooth the motion of the curtain between the retracted state and the deployed state. Additionally, or alternatively, the rapid switching can be executed above the audible range for humans (e.g., such that the rapid switching does not cause a distraction during an emergency).

At block 424, the process 400 includes detecting a bottom of the descent (e.g., based on an end-of-descent condition). The bottom can be detected by measuring a distance traveled by the curtain (e.g., via measurements in the motor, pulleys attached to the curtain, and/or the like) compared to a known deployment distance. Additionally, or alternatively, the bottom can be detected by measuring the speed of the curtain during deployment (e.g., via encoders coupled to the curtain). When the speed is zero, the process 400 can assume that the curtain is resting on the floor (or other suitable surface) at the bottom of the descent.

At block 426, in response to the detected bottom, the process 400 includes stopping the deployment operation. Stopping deployment operation can include stopping switching the deploying circuit between the fast decay setting and the slow decay setting. Additionally, or alternatively, the process 400 can include sending one or more signals at block 426 indicating the completion of the deployment (e.g., to the FSCS module 230 of FIG. 2), allowing the status of the deployable barrier system to be remotely monitored, confirmed, and/or recorded.

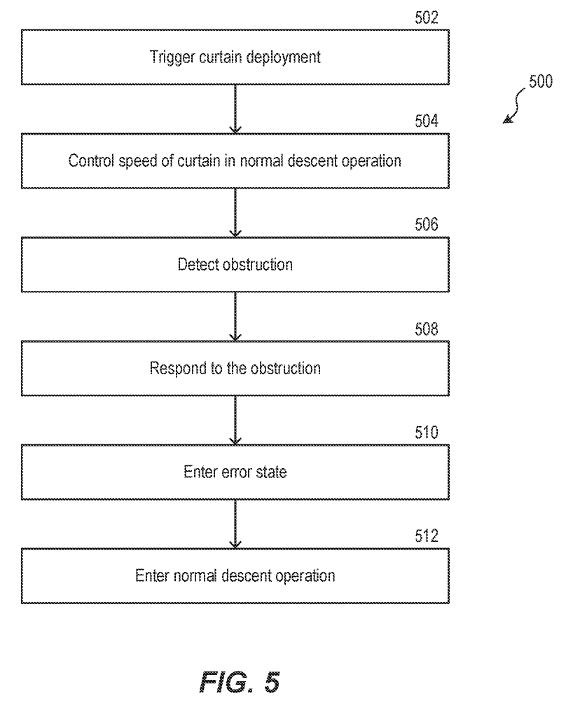

FIG. 5 is a flow diagram of a process 500 for controlling descent of a curtain of a deployable barrier system during deployment in accordance with embodiments of the present technology. More specifically, the process 500 illustrated in FIG. 5 can be executed to respond to an obstruction while deploying a curtain of a deployable barrier system. Similar to the discussion above, the process 500 can be executed by a controller in the deployable barrier system (e.g., the controller 124 discussed above with reference to FIG. 1 and/or the controller 212 discussed above with reference to FIG. 2). Additionally, or alternatively, various portions of the process 500 can be executed by any other suitable component in communication with the deployable barrier system. Further, the process 500 can be executed, in part, using a deploying circuit of the type discussed above with reference to FIG. 3.

The process 500 begins at block 502 by triggering curtain deployment. Similar to the discussion above, the process 500 can trigger the curtain deployment in response to a detection of smoke, fumes, fire, noxious gasses, and/or any other hazard in the vicinity of the deployable barrier system, inputs received from another component coupled to the deployable barrier system (e.g., inputs from the FSCS module 230 of FIG. 2), inputs from a manual switch in the deployable barrier system (e.g., the manual switch 138 of FIG. 1), and/or the like. Further, the process 500 at block 502 can include opening one or more doors in the deployable barrier system to allow a curtain to be pulled by gravity from a retracted position toward a deployed position. Additionally, or alternatively, process 500 at block 502 can include releasing one or more brakes applied to the curtain and/or a motor coupled thereto to enable the curtain to begin descending.

At block 504, the process 500 includes controlling a speed of the curtain in a normal descent operation. The normal descent operation can be generally similar to the process 400 discussed above with reference to block 404 to rapidly switch between a fast decay setting and a slow decay setting of a deploying circuit. The normal operation can control the speed of the curtain such that the curtain moves in a vertical direction at a speed of between six ips and about twenty-four ips, between about eight ips and about fifteen ips, or about eleven ips. In some embodiments, the normal operation includes an acceleration period at the start of the curtain deployment (e.g., to accelerate the curtain). In such embodiments, the process 500 can modify a ratio between a first portion of a modulation period spent in the fast decay setting and a second portion of the modulation period spent in a slow decay setting during the normal operation.

At block 506, the process 500 includes detecting an obstruction to the curtain. The obstruction can be a human passing (or positioned) beneath the curtain, an object (e.g., desk, chair, office cart, and/or the like) beneath the curtain, and/or any other object that can impede the path of the curtain during deployment. The obstruction can be detected by motion sensors, proximity sensors, machine vision sensors, and/or the like monitoring a travel path (and/or space around the travel path) for the curtain during deployment. Additionally, or alternatively, the obstruction can be detected based on the speed of the curtain during deployment as measured by one or more encoders of the deployable barrier system. For example, when the curtain encounters (e.g., lands on and/or is otherwise impeded by) the obstruction, the speed of the curtain can be reduced (or stopped altogether). In some such embodiments, the detection of the obstruction includes comparing a deployed distance to an expected fully deployed distance (e.g., to confirm that the curtain is not fully deployed instead of obstructed).

At block 508, the process 500 includes responding to the obstruction. The response can include pausing the descent of the curtain. For example, the response can include applying a brake to the motor and/or any other suitable component for a predetermined time period to prevent the motor from driving in reverse during the predetermined time period. Additionally, or alternatively, the response can include altering the ratio between the fast decay setting and the slow decay setting (e.g., such that the deploying circuit is primarily in the slow decay setting to reduce the speed of the curtain). The pause and/or slower operation can provide time, for example, for a human in the proximity of the curtain to move through a passageway the curtain will block (e.g., to move toward safety, respond to an emergency, and/or the like) and/or otherwise get away from the curtain. The pause and/or slower operation can be executed for any suitable amount of time and/or until a detected obstruction is removed (e.g., until motion sensors do not detect motion beneath the curtain). Additionally, or alternatively, the response can include retracting the curtain a predetermined distance. Similar to the pause, the retraction can allow a human to move beneath the curtain. Further, the retraction can help allow the curtain to reroute around an inanimate obstruction.

At optional block 510, the process 500 includes entering an error state to control the speed of the curtain. The error state can be generally similar to the normal operation discussed above (e.g., switching the deploying circuit between the fast decay and slow decay settings) but configured to deploy the curtain more slowly than normal operation. For example, the deploying circuit can spend more time in the slow decay setting in the error state than in normal operation, thereby reducing the speed of the curtain as it is deployed. The error state can be useful, for example, to continue to provide humans near the curtain with time to move through the passageway. Additionally, or alternatively, the slower motion in the error state can help improve safety around the curtain and/or the chance that the curtain is damaged in response to reencountering the obstruction.

At optional block 512, the process 500 re-enters the normal descent operation discussed above with reference to block 504. The normal descent operation allows the curtain to complete deployment relatively quickly after the obstruction is no longer present. The process 500 can re-enter the normal descent operation after a preset time in the error state, after detecting the obstruction is no longer present, and/or immediately after responding to the obstruction (e.g., after pausing the descent, rather than entering the error state at optional block 510). In some embodiments, the process 500 omits optional block 512. In such embodiments, the process 500 can complete the deployment of the curtain in the error state discussed above with reference to optional block 510.

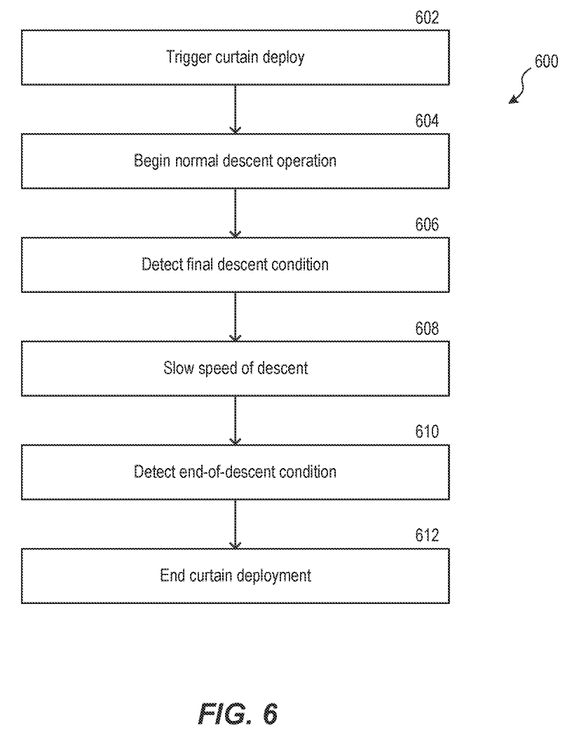

FIG. 6 is a flow diagram of a process 600 for controlling descent of a curtain of a deployable barrier system during deployment in accordance with further embodiments of the present technology. More specifically, the process 600 illustrated in FIG. 6 can be executed to provide a soft landing for the deployable barrier. Similar to the discussion above, the process 600 can be executed by a controller in the deployable barrier system (e.g., the controller 124 discussed above with reference to FIG. 1 and/or the controller 212 discussed above with reference to FIG. 2). Additionally, or alternatively, various portions of the process 600 can be executed by any other suitable component in communication with the deployable barrier system. Further, the process 600 can be executed, in part, using a deploying circuit of the type discussed above with reference to FIG. 3.

The process 600 begins at block 602 by triggering curtain deployment. Similar to the discussion above, the process 600 can trigger the curtain deployment in response to a detection of smoke, fumes, fire, noxious gasses, and/or any other hazard in the vicinity of the deployable barrier system, inputs received from another component coupled to the deployable barrier system (e.g., inputs from the FSCS module 230 of FIG. 2), inputs from a manual switch in the deployable barrier system (e.g., the manual switch 138 of FIG. 1), and/or the like. Further, the process 600 at block 602 can include opening one or more doors in the deployable barrier system to allow a curtain to be pulled by gravity from a retracted position toward a deployed position. Additionally, or alternatively, process 600 at block 602 can include releasing one or more brakes applied to the curtain and/or a motor coupled thereto to enable the curtain to begin descending.

At block 604, the process 600 includes controlling a speed of the curtain in a normal descent operation. The normal descent operation can be generally similar to the process 400 discussed above with reference to block 404 to rapidly switch between a fast decay setting and a slow decay setting of a deploying circuit. In some embodiments, the normal operation includes an acceleration period at the start of the curtain deployment (e.g., to accelerate the curtain). In such embodiments, the process 600 can modify a ratio between a first portion of a modulation period spent in the fast decay setting and a second portion of the modulation period spent in a slow decay setting during the normal operation.

At block 606, the process 600 includes detecting a final descent condition. The final descent condition can be based on a distance traveled by the curtain (e.g., that the curtain has traveled 70%, 80%, 90%, 95%, and/or the like of a known distance to deploy), a reduction in the force from gravity (e.g., in response to less mass in a spool left to unwind), a reduction in speed (e.g., in response to the smaller amount of curtain being pulled and driving the inductor), and/or the like. The detection can be made by measurements at a controller implementing the process and/or in response to signals received at the controller.

At block 608, the process 600 includes slowing a speed of the descent of the curtain. The slowdown can allow the curtain (and/or other components of the deployable barrier) to have a soft landing in the fully deployed position. The soft landing, in turn, can help reduce damage to the deployable barrier (and/or the building) to help extend the lifetime of the deployable barrier and/or reduce maintenance required after the deployment. As discussed above, the speed of the descent can be controlled by varying the ratio between the time the deploying circuit spends in the fast decay setting and the time the deploying circuit spends in the slow decay setting in each modulation period. Accordingly, the slowdown at block 608 can include increasing the amount of time the deploying circuit spends in the slow decay setting during each modulation period (e.g., increasing the ratio of time in slow decay vs time in fast decay). In some embodiments, the slowdown can be aided by one or more mechanical components (e.g., applying the brake 219 of FIG. 2).

At block 610, the process 600 includes detecting an end-of-descent condition. Similar to the discussion above, the end-of-descent condition can be based on a distance traveled by the curtain and compared to a known deployment distance. Additionally, or alternatively, the end-of-descent condition can be based on the speed of the curtain (e.g., measured via encoders coupled to the curtain, sensors in the motor, and/or the like). When the speed is zero, the process 600 can detect that the curtain is fully deployed.

At block 612, in response to the end-of-descent condition, the process 600 includes ending the curtain deployment. Ending the curtain deployment can include stopping switching the deploying circuit between the fast decay setting and the slow decay setting. Additionally, or alternatively, the process 600 can include sending one or more signals at block 612 indicating the completion of the deployment (e.g., to the FSCS module 230 of FIG. 2), allowing the status of the deployable barrier system to be remotely monitored, confirmed, and/or recorded.

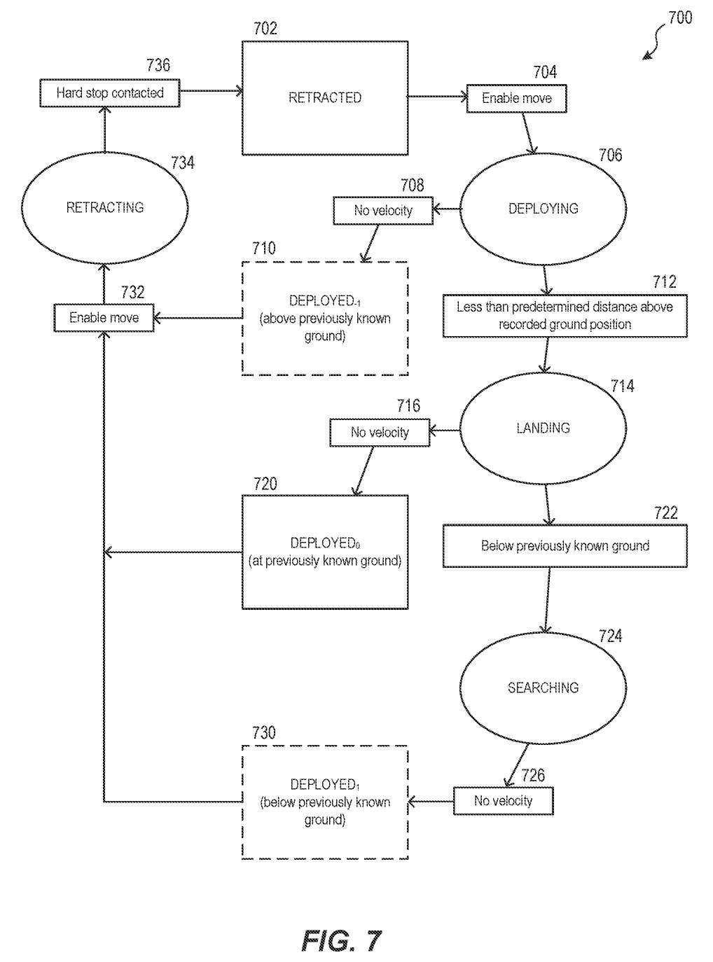

FIG. 7 is a flow diagram of a process 700 for deploying a curtain of a deployable barrier system in accordance with further embodiments of the present technology. More specifically, the process 700 illustrated in FIG. 7 can be executed to self-calibrate and/or re-calibrate a deployable barrier system in accordance with some embodiments of the present technology. Similar to the discussion above, the process 700 can be executed by a controller in the deployable barrier system (e.g., the controller 124 discussed above with reference to FIG. 1 and/or the controller 212 discussed above with reference to FIG. 2). Additionally, or alternatively, various portions of the process 700 can be executed by any other suitable component in communication with the deployable barrier system. Further, the process 700 can be executed, in part, using a deploying circuit of the type discussed above with reference to FIG. 3.

The process 700 begins with the deployable barrier in the retracted position 702. In the retracted position 702, the deployable barrier can be fully (or primarily) contained within a housing and/or compartment of the deployable barrier system above a passageway.

At block 704, the process 700 includes enabling the deployable barrier to move. Similar to the discussion above with respect to FIGS. 4-6, the process 700 at block 704 can include opening one or more doors in the deployable barrier system to allow the deployable barrier to be pulled by gravity from a retracted position toward a deployed position and/or releasing one or more brakes applied to the curtain and/or a motor coupled thereto to enable the deployable barrier to move.

Once the deployable barrier is moving, the process 700 enters a normal deploying operation 706. During normal deploying operation 706, the process 700 can include controlling a speed of the curtain. The normal deploying operation 706 can be generally similar to the process 400 discussed above with reference to block 404 to rapidly switch between a fast decay setting and a slow decay setting of a deploying circuit. As a result, the normal deploying operation 706 can control the speed of the deployable barrier such that the deployable barrier moves in a vertical direction at a predetermined speed (e.g., at about eleven ips). The process 700 can continue in the normal deploying operation 706 until an end-of-descent condition is detected at block 708 or a final descent condition is detected at block 712.

For example, at block 708, the process 700 can detect that the deployable barrier has no velocity and determine that the deployable barrier is fully deployed. As a result, the process 700 can stop switching the deploying circuit between the fast decay setting and the slow decay setting. Additionally, or alternatively, the process 700 can include sending one or more signals at block 708 indicating the completion of the deployment (e.g., to the FSCS module 230 of FIG. 2), allowing the status of the deployable barrier system to be remotely monitored, confirmed, and/or recorded.

Further, as illustrated in FIG. 7, the process 700 at block 708 results in the deployable barrier being in a first deployed position 710 that is above a previously known ground position (e.g., the second deployed position 720 discussed below). The first deployed position 710 can represent a more accurate setting for the deployed position of the deployable barrier, for example when the deployable barrier system is incorrectly installed and/or calibrated. Additionally, or alternatively, the first deployed position 710 can represent a new ground position (e.g., when a passageway such as a window, opening in a wall, and/or the like is remodeled and the ground position changes). Accordingly, the process 700 at block 708 can include recording the first deployed position 710 for the deployable barrier system to expect the first deployed position 710 during the next deployment.

Alternatively, at block 712, the process 700 detects a final descent condition, such as the deployable barrier being less than a predetermined distance (e.g., two feet, one foot, six inches, and/or any other suitable distance) above a recorded ground position (e.g., default ground position, a ground position from calibration, a ground position from last deployment, and/or the like). In response to the detection of the final descent condition at block 712, the process 700 can enter a landing operation 714.

Similar to the process 600 discussed above with reference to block 608 of FIG. 6, the landing operation 714 of FIG. 7 can include reducing the speed of the deployable barrier. Further, the reduction in the speed can be accomplished by altering a ratio between the time the deploying circuit spends in the fast decay setting compared to the time the deploying circuit spends in the slow decay setting (e.g., increasing the time spent in the slow decay setting). The landing operation 714 can help reduce the chance that the deployable barrier is damaged (or causes damage) as the deployable barrier reaches the end of the descent.

At block 716, the process 700 can detect an end-of-descent condition (e.g., that the deployable barrier has no velocity) and determine that the deployable barrier is fully deployed. As a result, the process 700 can stop switching the deploying circuit between the fast decay setting and the slow decay setting. Additionally, or alternatively, the process 700 can include sending one or more signals at block 716 indicating the completion of the deployment (e.g., to the FSCS module 230 of FIG. 2), allowing the status of the deployable barrier system to be remotely monitored, confirmed, and/or recorded.

Still further, as illustrated in FIG. 7, the process 700 at block 716 results in the deployable barrier being in the second deployed position 720 that is generally equivalent to a previously known ground position. That is, the second deployed position 720 can represent an accurate setting for the deployed position of the deployable barrier following a calibration and/or a previous deployment (and resulting re-calibration). Accordingly, the process 700 at block 716 can include recording the second deployed position 720 for the deployable barrier system to continue to expect the second deployed position 720.

Conversely, if no end-of-descent condition is detected, the process 700 can continue to block 722 to detect that it is below the previously known ground position and allow the deployable barrier to continue to descend. As a result, the process 700 can enter a searching operation 724. The searching operation 724 can be generally similar to the normal deploying operation 706 and/or the landing operation 714 to allow the deployable barrier to continue to move in a vertical direction. For example, the deployable barrier can continue to move at a reduced speed (e.g., generally similar to the landing operation 714) until an end-of-descent condition is detected and/or the deployable barrier reaches a point where it cannot be further deployed. (e.g., no more slack in the spool 131 of FIG. 1).

At block 726, the process 700 detects an end condition (e.g., that the deployable barrier has no velocity due to an end-of-descent condition and/or end-of-supply condition) and determines that the deployable barrier is fully deployed. As a result, the process 700 can stop switching the deploying circuit between the fast decay setting and the slow decay setting. Additionally, or alternatively, the process 700 can include sending one or more signals at block 726 indicating the completion of the deployment (e.g., to the FSCS module 230 of FIG. 2), allowing the status of the deployable barrier system to be remotely monitored, confirmed, and/or recorded.

Still further, as illustrated in FIG. 7, the process 700 at block 716 results in the deployable barrier being in a third deployed position 730 that is below a previously known ground position (e.g., the second deployed position 720 discussed above). The third deployed position 730 can represent a more accurate setting for the deployed position of the deployable barrier, for example when the deployable barrier system is incorrectly installed and/or calibrated. Additionally, or alternatively, the third deployed position 730 can represent a new ground position (e.g., when a passageway such as a window, opening in a wall, and/or the like is remodeled and the ground position changes). Accordingly, the process 700 at block 726 can include recording the third deployed position 730 for the deployable barrier system to expect the third deployed position 730 during the next deployment.

After the deployable barrier blocks smoke, fumes, fire, noxious gasses, and/or the like in any of the first–third deployed positions 710, 720, 730, the process 700 can move to block 732. At block 732, the process 700 enables the movement of the deployable barrier to return to a retracted position. The enablement at block 732 can be responsive to one or more inputs and/or commands received by the deployable barrier system (e.g., a return to normal command from the FSCS module 230 of FIG. 2; signals received from a manual switch; and/or the like). Further, the process 700 at block 732 can include releasing a brake (if applied) on the deployable barrier and applying a drive current to the motor in the deployable barrier system (e.g., along the first flow path 1 discussed above with reference to FIG. 3). As a result, the process 700 enters a retracting operation 734 that returns the deployable barrier from the deployed position toward the retracted position.

The process 700 can continue in the retracting operation 734 until the process 700 detects a completed retraction condition at block 736 (e.g., contact between the deployable barrier and a hard stop). Once the completed retraction condition is detected at block 736, the process 700 can apply a brake to the deployable barrier, close a door of a housing to contain the deployable barrier, and/or otherwise reset to the retracted position 702.

### Examples

The present technology is illustrated, for example, according to various aspects described below. Various examples of aspects of the present technology are described as numbered examples (1, 2, 3, etc.) for convenience. These are provided as examples and do not limit the present technology. It is noted that any of the dependent examples can be combined in any suitable manner, and placed into a respective independent example. The other examples can be presented in a similar manner.

1. A deployable barrier system for blocking transmission of smoke through a passageway, the deployable barrier system comprising: a housing having an opening; a deployable barrier positioned to move between a retracted position and a deployed position, wherein the deployable barrier comprises a curtain configured to cover the passageway and block smoke from moving through the passageway when the deployable barrier is in the deployed position; a motor operably coupled to the deployable barrier so that a weight of the curtain drives the motor in reverse during deployment of the deployable barrier system, wherein the motor includes an inductive component positioned to generate a current in response to the motor driving in reverse; a deploying circuit operatively coupled to the motor, the deploying circuit having a first setting and a second setting, wherein: in the first setting, the deploying circuit applies the current to an output of the deploying circuit to dissipate the current; and in the second setting, the deploying circuit applies the current as a load upstream from the inductive component to resist driving the motor in reverse; and a controller operably coupled to the deploying circuit to switch the deploying circuit between the first setting and the second setting to control a speed of the motor driving in reverse.

2. The deployable barrier system of example 1 wherein: the deploying circuit is an H-bridge circuit that includes the inductive component of the motor, wherein the H-bridge circuit includes a first end coupled to the output of the deploying circuit and a second end coupled to a ground for the deploying circuit; the first end includes a first switch on a first side of the H-bridge circuit and a third switch on a second side of the H-bridge circuit; and the second end includes a second switch on the first side of the H-bridge circuit and a fourth switch on the second side of the H-Bridge circuit.

3. The deployable barrier system of example 2 wherein: in the first setting, the first switch and the fourth switch are open, and the second switch and the third switch are closed; and in the second setting, the first switch and the third switch are open, and the second switch and the fourth switch are closed.

4. The deployable barrier system of any of examples 2 and 3 wherein each of the first–fourth switches comprises a bipolar field-effect transistor (FET) that can be opened and closed by the controller via a pulse width modulation (PWM) signal.

5. The deployable barrier system of example 4 wherein each of the first–fourth switches further comprises a catch diode.

6. The deployable barrier system of any of examples 1–5 wherein the controller is configured to switch the deploying circuit between the first setting and the second setting between 1,000 times per second and 40,000 times per second.

7. The deployable barrier system of any of examples 1–6 wherein the controller is configured to set the deploying circuit in the first setting for a first period of a cycle and set the deploying circuit in the second setting for a second period in the cycle, wherein the first period is longer than the second period.

8. The deployable barrier system of any of examples 1–7 wherein the controller is configured to adjust a cycle of the deploying circuit to adjust a ratio between a first time the deploying circuit is in the first setting and a second time the deploying circuit is in the second setting to alter a speed of the curtain during deployment of the deployable barrier system.

9. The deployable barrier system of any of examples 1–9 further comprising one or more encoders communicably coupled to the controller and positioned to measure a speed of the curtain during deployment.

10. The deployable barrier system of example 9 wherein the controller is configured to: detect, based on signals from the one or more encoders, an obstruction to the deployable barrier system during deployment; and in response to the obstruction, apply a brake to the motor for a predetermined time period to prevent the motor from driving in reverse during the predetermined time period.

11. The deployable barrier system of example 10 wherein the controller is further configured to, after the predetermined time period, adjust increase an amount of time the deploying circuit spends in the slow decay setting during a cycle of the deploying circuit compared to the deployment of the deployable barrier system before the obstruction.

12. The deployable barrier system of any of examples 1–11 further comprising a battery operably coupled to the output of the deploying circuit, wherein, in the first setting the deploying circuit applies the current to the output to charge the battery.

13. The deployable barrier system of any of examples 1–12 wherein the controller is coupled to the output of the deploying circuit, and wherein, in the first setting the deploying circuit applies the current to the output to at least partially power the controller.

14. A method for deploying a barrier system for blocking transmission of smoke through a passageway, the method comprising: detecting a deployment condition to trigger deployment of a curtain, wherein the curtain is movable between a retracted state and a deployed state; and controlling an H-bridge circuit having an inductor of a motor operatively coupled to the curtain to control a speed of the curtain during a decent in response to being pulled toward the deployed state by gravity, wherein controlling the H-bridge circuit comprises: for a first portion of a modulation period, setting the H-bridge circuit in a fast-decay mode; and for a second portion of the modulation period, setting the H-bridge circuit in a slow decay mode.

15. The method of example 14 wherein: the H-bridge circuit includes a top end coupled to an outlet of the H-bridge circuit and a bottom end coupled to a ground for the H-bridge circuit, wherein the top end includes a first switch and a third switch, and wherein the bottom end includes a second switch and a fourth switch; setting the H-bridge circuit in the fast-decay mode comprises closing the third switch and opening the fourth switch; and setting the H-bridge circuit in the slow decay mode comprises opening the third switch and closing the fourth switch.

16. The method of any of examples 14 and 15 wherein the first portion of the modulation period is greater than the second portion of the modulation period.

17. The method of any of examples 14–16 further comprising: detecting an obstruction to the curtain during the decent; pausing the decent for a predetermined time period, wherein pausing the decent comprises applying a brake to the motor to prevent the curtain from moving in a vertical direction toward the deployed state; and after the predetermined time period, controlling the H-bridge circuit to allow the curtain to move in the vertical direction toward the deployed state in an error state, wherein controlling the H-bridge circuit comprises: for a third portion of the modulation period, setting the H-bridge circuit in the fast-decay mode, wherein the third portion is smaller than the first portion; and for a fourth portion of the modulation period, setting the H-bridge circuit in the slow decay mode, wherein the fourth portion is larger than the second portion.

18. The method of any of examples 14–17 further comprising: detecting no velocity in the curtain at a first elevation above a second elevation, wherein the second elevation is expected for the deployed state; and updating the deployed state to expect the first elevation during subsequent descents of the curtain.

19. The method of any of examples 14–18 further comprising: detecting that the curtain is at a predetermined elevation above an expected elevation for the deployed state; and in response to the detection, controlling the H-bridge circuit to allow the curtain to move in a vertical direction toward the deployed state in a landing state, wherein controlling the H-bridge circuit comprises: for a third portion of the modulation period, setting the H-bridge circuit in the fast-decay mode, wherein the third portion is smaller than the first portion; and for a fourth portion of the modulation period, setting the H-bridge circuit in the slow decay mode, wherein the fourth portion is larger than the second portion.

20. The method of any of examples 14–19, further comprising: detecting no velocity in the curtain at a first elevation below a second elevation, wherein the second elevation is expected for the deployed state; and updating the deployed state to expect the first elevation during subsequent descents of the curtain.

21. A non-transitory computer-readable storage medium storing instructions that, when executed by a computing system, cause the computing system to perform operations for operating a deployable barrier system to deploy a smoke curtain, the operations comprising: detecting a deployment condition to trigger deployment of the smoke curtain, wherein the curtain is movable between a retracted state and a deployed state; and controlling a deploying circuit having an inductor of a motor, wherein the motor is operatively coupled to the smoke curtain to control a speed of the smoke curtain during a decent toward the deployed state, wherein controlling the deploying circuit comprises, for each individual modulation period during the decent toward the deployed state: for a first portion of the individual modulation period, setting the deploying circuit in a fast-decay mode; and for a second portion of the individual modulation period, setting the deploying circuit in a slow decay mode.

22. The non-transitory computer-readable storage medium of example 21 wherein: the deploying circuit is an H-bridge circuit centered around the inductor, wherein the H-bridge circuit includes a top end coupled to an outlet of the H-bridge circuit and a bottom end coupled to a ground for the H-bridge circuit, wherein the top end includes a first switch and a third switch, and wherein the bottom end includes a second switch and a fourth switch; setting the deploying circuit in the fast-decay mode comprises closing the third switch and opening the fourth switch; and setting the deploying circuit in the slow decay mode comprises opening the third switch and closing the fourth switch.

### Conclusion

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where the context permits, singular or plural terms may also include the plural or singular term, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Further, the terms “approximately,” “generally,” and “about” are used herein to mean within at least within 10% of a given value or limit. Purely by way of example, an approximate ratio means within 10% of the given ratio.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments.

Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

We claim:

1. A deployable barrier system for blocking transmission of smoke through a passageway, the deployable barrier system comprising:
a housing having an opening;
a deployable barrier positioned to move between a retracted position and a deployed position, wherein the deployable barrier comprises a curtain configured to cover the passageway and block smoke from moving through the passageway when the deployable barrier is in the deployed position;
a motor operably coupled to the deployable barrier so that a weight of the curtain drives the motor in reverse during deployment of the deployable barrier system, wherein the motor includes an inductive component positioned to generate a current in response to the motor driving in reverse;
a deploying circuit operatively coupled to the motor, the deploying circuit having a first setting and a second setting, wherein:
in the first setting, the deploying circuit applies the current to an output of the deploying circuit to dissipate the current; and
in the second setting, the deploying circuit applies the current as a load upstream from the inductive component to resist driving the motor in reverse; and
a controller operably coupled to the deploying circuit to switch the deploying circuit between the first setting and the second setting to control a speed of the motor driving in reverse.

2. The deployable barrier system of claim 1 wherein:
the deploying circuit is an H-bridge circuit that includes the inductive component of the motor, wherein the H-bridge circuit includes a first end coupled to the output of the deploying circuit and a second end coupled to a ground for the deploying circuit;
the first end includes a first switch on a first side of the H-bridge circuit and a third switch on a second side of the H-bridge circuit; and
the second end includes a second switch on the first side of the H-bridge circuit and a fourth switch on the second side of the H-Bridge circuit.

3. The deployable barrier system of claim 2 wherein:
in the first setting, the first switch and the fourth switch are open, and the second switch and the third switch are closed; and
in the second setting, the first switch and the third switch are open, and the second switch and the fourth switch are closed.

4. The deployable barrier system of claim 1, further comprising a battery operably coupled to the output of the deploying circuit, wherein, in the first setting the deploying circuit applies the current to the output to charge the battery.

5. The deployable barrier system of claim 1 wherein the controller is coupled to the output of the deploying circuit, and wherein, in the first setting the deploying circuit applies the current to the output to at least partially power the controller.

6. The deployable barrier system of claim 1 wherein the controller is configured to switch the deploying circuit between the first setting and the second setting between 1,000 times per second and 40,000 times per second.

7. The deployable barrier system of claim 1 wherein the controller is configured to set the deploying circuit in the first setting for a first period of a cycle and set the deploying circuit in the second setting for a second period in the cycle, wherein the first period is longer than the second period.

8. The deployable barrier system of claim 1 wherein the controller is configured to adjust a cycle of the deploying circuit to adjust a ratio between a first time the deploying circuit is in the first setting and a second time the deploying circuit is in the second setting to alter a speed of the curtain during deployment of the deployable barrier system.

9. The deployable barrier system of claim 1, further comprising one or more encoders communicably coupled to the controller and positioned to measure a speed of the curtain during deployment.

10. The deployable barrier system of claim 9 wherein the controller is configured to:
detect, based on signals from the one or more encoders, an obstruction to the deployable barrier system during deployment; and
in response to the obstruction, apply a brake to the motor for a predetermined time period to prevent the motor from driving in reverse during the predetermined time period.

11. The deployable barrier system of claim 10 wherein the controller is further configured to, after the predetermined time period, adjust increase an amount of time the deploying circuit spends in the second setting during a cycle of the deploying circuit compared to the deployment of the deployable barrier system before the obstruction.

12. A method for deploying a barrier system for blocking transmission of smoke through a passageway, the method comprising:
detecting a deployment condition to trigger deployment of a curtain, wherein the curtain is movable between a retracted state and a deployed state; and
controlling an H-bridge circuit having an inductor of a motor operatively coupled to the curtain to control a speed of the curtain during a decent in response to being pulled toward the deployed state by gravity, wherein controlling the H-bridge circuit comprises:
for a first portion of a modulation period, setting the H-bridge circuit in a fast-decay mode; and
for a second portion of the modulation period, setting the H-bridge circuit in a slow decay mode.

13. The method of claim 12 wherein:
the H-bridge circuit includes a top end coupled to an outlet of the H-bridge circuit and a bottom end coupled to a ground for the H-bridge circuit, wherein the top end includes a first switch and a third switch, and wherein the bottom end includes a second switch and a fourth switch;
setting the H-bridge circuit in the fast-decay mode comprises closing the third switch and opening the fourth switch; and
setting the H-bridge circuit in the slow decay mode comprises opening the third switch and closing the fourth switch.

14. The method of claim 12 wherein the first portion of the modulation period is greater than the second portion of the modulation period.

15. The method of claim 12, further comprising:
detecting an obstruction to the curtain during the decent;
pausing the decent for a predetermined time period, wherein pausing the decent comprises applying a brake to the motor to prevent the curtain from moving in a vertical direction toward the deployed state; and
after the predetermined time period, controlling the H-bridge circuit to allow the curtain to move in the vertical direction toward the deployed state in an error state, wherein controlling the H-bridge circuit comprises:
for a third portion of the modulation period, setting the H-bridge circuit in the fast-decay mode, wherein the third portion is smaller than the first portion; and
for a fourth portion of the modulation period, setting the H-bridge circuit in the slow decay mode, wherein the fourth portion is larger than the second portion.

16. The method of claim 12, further comprising:
detecting no velocity in the curtain at a first elevation above a second elevation, wherein the second elevation is expected for the deployed state; and
updating the deployed state to expect the first elevation during subsequent descents of the curtain.

17. The method of claim 12, further comprising:
detecting that the curtain is at a predetermined elevation above an expected elevation for the deployed state; and
in response to the detection, controlling the H-bridge circuit to allow the curtain to move in a vertical direction toward the deployed state in a landing state, wherein controlling the H-bridge circuit comprises:
for a third portion of the modulation period, setting the H-bridge circuit in the fast-decay mode, wherein the third portion is smaller than the first portion; and
for a fourth portion of the modulation period, setting the H-bridge circuit in the slow decay mode, wherein the fourth portion is larger than the second portion.

18. The method of claim 12, further comprising:
detecting no velocity in the curtain at a first elevation below a second elevation, wherein the second elevation is expected for the deployed state; and
updating the deployed state to expect the first elevation during subsequent descents of the curtain.

19. A non-transitory computer-readable storage medium storing instructions that, when executed by a computing system, cause the computing system to perform operations for operating a deployable barrier system to deploy a smoke curtain, the operations comprising:
detecting a deployment condition to trigger deployment of the smoke curtain, wherein the smoke curtain is movable between a retracted state and a deployed state; and
controlling a deploying circuit having an inductor of a motor, wherein the motor is operatively coupled to the smoke curtain to control a speed of the smoke curtain during a decent toward the deployed state, wherein controlling the deploying circuit comprises, for each individual modulation period during the decent toward the deployed state:
for a first portion of the individual modulation period, setting the deploying circuit in a fast-decay mode; and
for a second portion of the individual modulation period, setting the deploying circuit in a slow decay mode.

20. The non-transitory computer-readable storage medium of claim 19 wherein:
the deploying circuit is an H-bridge circuit centered around the inductor, wherein the H-bridge circuit includes a top end coupled to an outlet of the H-bridge circuit and a bottom end coupled to a ground for the H-bridge circuit, wherein the top end includes a first switch and a third switch, and wherein the bottom end includes a second switch and a fourth switch;
setting the deploying circuit in the fast-decay mode comprises closing the third switch and opening the fourth switch; and
setting the deploying circuit in the slow decay mode comprises opening the third switch and closing the fourth switch.
